(19) United States
(12) Patent Application Publication
(10) Pub. No.: US 2018/0320419 A1
(43) Pub. Date: Nov. 8, 2018

(54) SYSTEM AND METHOD FOR REMOTELY LOCKING AND UNLOCKING A VEHICLE

(71) Applicant: ELIOCITY, Marquette lez Lille (FR)

(72) Inventors: Timothée HAUGEDE, Mouvaux (FR); Romain CRUNELLE, Lille (FR)

(21) Appl. No.: 15/773,831

(22) PCT Filed: Oct. 24, 2016
(86) PCT No.: PCT/EP2016/075586

§ 371 Date: May 4, 2018

(30) Foreign Application Priority Data
Nov. 4, 2015 (FR) 1560588

(51) Int. Cl. E05B 81/06; E05B 81/56; E05B 81/64; B60R 25/24

(52) U.S. Cl. CPC E05B 81/06; E05B 81/56; E05B 81/64; B60R 25/24; E05Y 2400/66; E05Y 2400/40; E05Y 2400/44; E05Y 2400/85; E05Y 2900/531; E05Y 2201/434

(57) ABSTRACT

Some embodiments relates to a system for remotely locking and unlocking a vehicle equipped with a central closing controlled via a remote control, the system including an electronic device and a data processing facility, the electronic device configured to be arranged within the vehicle and being able to be linked to the remote control via a data link, the electronic device being linked to the data processing facility via a communication network and including a communicator for communicating over the data link and a communicator for communicating over the communication network, in which the data processing facility is able, following receiving a message associated with a command for locking or unlocking the vehicle, to emit, on the communication network destined for the electronic device, a first signal for controlling locking or unlocking of the vehicle, so that the electronic device dispatches to the remote control a second corresponding control signal.

### CROSS REFERENCE TO RELATED APPLICATIONS

This application is a national phase filing under 35 C.F.R. § 371 of and claims priority to PCT Patent Application No. PCT/EP2016/075586, filed on Oct. 24, 2016, which claims the priority benefit under 35 U.S.C. § 119 of French Patent Application No. 1560588, filed on Nov. 4, 2015, the contents of each of which are hereby incorporated in their entireties by reference.

### BACKGROUND

Some embodiments generally relate to accessing a vehicle, and more particularly to a system and a method for remotely locking and unlocking a vehicle equipped with central locking. Systems of this type permit a user to be able to lock and unlock a vehicle remotely, without necessarily being in possession of the keys to the vehicle beforehand.

Systems for remotely locking and unlocking a vehicle equipped with central locking are known.

Certain systems include a central on-board computer in the vehicle, which is designed to control the central locking system, and a data processing equipment which is connected to the central on-board computer via a wireless communication network. This applies, for example, to the system described in document FR 3 006 485 A1. In this system, the vehicle is equipped with a badge which permits access to the vehicle. The badge contains a vehicle identification code. A portable user communication device, equipped with a contactless badge reader, permits the retrieval of this authentication code by the reading of the badge. Once this code has been transmitted by the portable device to the data processing equipment, together with a specific command code, the equipment is able to submit to the central on-board computer a control signal for the locking or unlocking of the vehicle, via the communication network.

However, a system of this type is compatible with very few models of vehicle; it is necessary, firstly, that the on-board computer in the vehicle should be suitable for communication on a wireless communication network, and secondly that the data processing equipment should be specifically configured for this communication, for each compatible model of vehicle. Accordingly, in addition to the problem of interoperability, such a solution is restrictive in its application.

Refinements of these systems exist. For example, the use of a system for remotely locking and unlocking a vehicle is known, including a dedicated electronic device, which is arranged within the vehicle and connected to the data processing equipment via a wireless communication network. The electronic device is directly wired to the central on-board computer of the vehicle. The data processing equipment is able to transmit a control signal to the electronic device for the locking or unlocking of the vehicle, such that the on-board computer controls the locking or unlocking of the central locking system.

### SUMMARY

However, such a system involves the complex wiring of the electronic device to the on-board computer, thus requiring the deployment of a restrictive modification on the electrical system of the vehicle. Moreover, each wiring arrangement is specific to the model of vehicle concerned. A system of this type thus provides very little flexibility in use. In practice, once the electronic device has been wired to a first vehicle, it cannot easily be reused on a second vehicle.

Some embodiments described hereinafter are intended to rectify, in whole or in part, the disadvantages of the related art, and specifically propose a system for remotely locking and unlocking a vehicle which is flexible, simple, and compatible with a very large number of vehicles, and which requires no modification to the vehicle for the operation thereof.

Some embodiments are therefore directed to a system for remotely locking and unlocking a vehicle equipped with central locking controlled via a remote control. The system includes an electronic device and data processing equipment, the electronic device being adapted to be arranged within the vehicle and being able to be linked to the remote control via a data link, the electronic device being linked to the data processing equipment via a communication network. The system also includes a communicator for communicating over the data link and a communicator for communicating over the communication network. The data processing equipment is able, following the reception of a message associated with a command for locking or unlocking the vehicle, to emit, on the communication network for the attention of for the electronic device, a first signal for controlling the locking or unlocking of the vehicle, such that the electronic device sends to the remote control a second corresponding control signal, so as to lock or unlock the vehicle.

Due to the fact that the electronic device is suitable for connection to a remote control for central locking via a data link, and for the transmission thereto of a control signal corresponding to a first signal emitted by the data processing equipment, the locking or unlocking of the vehicle is executed via the remote control. Accordingly, the system according to some embodiments advantageously adapts to all vehicles equipped with central locking which is controllable via a remote control, in other words to a large number of vehicles. Moreover, the system according to some embodiments requires no complex modification of the vehicle.

According to a particular embodiment, the locking and unlocking system further includes an interfacing unit, which is connected between the electronic device and the remote control, the unit being designed to receive the second control signal and to emit, for the attention of the remote control, a third control signal for the locking or unlocking of the vehicle.

An interfacing unit of this type, which permits the conversion and transmission of input-output signals from the remote control and the electronic device, provides a simple and flexible device for the connection of the electronic device to the remote control.

Advantageously, the interfacing unit is configured for the reception from the remote control of information for the confirmation of the locking or unlocking of the vehicle, further to the reception by the remote control of the third control signal, and for the emission, on the data link for the attention of the electronic device, of a confirmation signal for the execution of the command for the locking or unlocking of the vehicle.

This permits the delivery to the data processing equipment of information, by the emission by the electronic device on the communication network of a corresponding confirmation signal. This information is intended to confirm or disprove the execution of the locking or unlocking command by the remote control. Thus, in the event of the non-execution of this locking or unlocking command by the remote control, the data processing equipment can advantageously relay the control signal on the communication network, for the attention of the remote control.

According to a particular embodiment, the data link is a wired link.

Advantageously, the wired link is a detachable link including, for example, a male connector and a female connector.

Such a characteristic provides a way to further enhance the flexibility of use of the locking and unlocking system according to some embodiments. Accordingly, the only preliminary operation for the installation of the system involves the modification of preexisting remote control of the vehicle by the soldering thereto, at certain key points on its printed circuit board, of an electric cable fitted with the male connector or the female connector. The other connector is connected to the electronic device. The electronic device can thus be easily connected to the remote control, by the mutual connection of the male and female connectors. Conversely, if the remote control further includes a starter key or button for the vehicle engine, a user can easily reuse the remote control for the start-up of the vehicle, once the vehicle has been unlocked.

According to another particular embodiment, the locking and unlocking system further includes a unit which is connected to the electronic device, the unit including a reception compartment for the remote control and an electromechanical device for the actuation of at least one locking or unlocking button for the vehicle, arranged on the remote control, the electromechanical device being designed for the reception of the second control signal and for the mechanical actuation of the locking or unlocking button, as a function of the value of this control signal.

This particular embodiment permits the avoidance of any preliminary physical intervention on the remote control, such intervention being necessary if an electronic connection is to be provided on the remote control. This permits the further simplification of the locking and unlocking system, in that no preliminary intervention operation on the remote control is required prior to the installation of the remote control in the system. Thus, the installation of the remote control in the system is reversible, and the remote control can advantageously be reused by the user a number of times, with no associated difficulty. Likewise, a new user of the system can easily integrate the remote control of their vehicle into the system, thereby obtaining an immediately operational system. The simplicity and flexibility of use of the locking and unlocking system are enhanced accordingly.

Advantageously, the unit further includes a bolt, which is capable of the mechanical locking or unlocking of the reception compartment, the reception compartment being installed so as to be moveable between a position of open access to the remote control, and a closed position, in which the remote control is no longer accessible from the exterior of the unit, the bolt being designed for the mechanical locking or unlocking of the reception compartment when the compartment is in its closed position.

These characteristics permit the enhancement of the robustness and the security of the system.

According to a particular technical embodiment, the electromechanical device for the actuation of at least one locking or unlocking button of the vehicle include at least one servo motor, which is moveable between two positions, and an electronic control unit for the movement of the or of each servo motor, the or each servo motor being equipped with an actuating arm, arranged opposite the or one of the locking or unlocking button(s) of the vehicle, and capable, in one of the two positions of the servo motor, of mechanically actuating the button.

Advantageously, the or each servo motor is equipped with a pressure sensor, which is capable of measuring the pressure applied to the locking or unlocking button of the vehicle during the actuation of this button by the arm of the servo motor.

By comparison with a threshold pressure value, this characteristic permits the acquisition of information for the confirmation or disproval of the correct engagement of the arm of the servo motor with the button. Information for the confirmation of the locking or unlocking of the vehicle is obtained thereafter. This information is reliable, in comparison with solutions employing the detection of an end-of-travel position of the arm. This information can then be delivered to the data processing equipment, by the preliminary transmission thereof by the unit to the electronic device, and thereafter by the emission, by the electronic device, of a corresponding confirmation signal on the communication network. Thus, in the event of the non-execution of this locking or unlocking command by the arm of the servo motor, the data processing equipment can advantageously relay the control signal on the communication network, for the attention of the remote control.

Advantageously, the electronic control unit for the movement of the or each servo motor is further connected to the bolt, and is capable of controlling the bolt in order to mechanically lock or unlock the reception compartment.

These characteristics permit the reduction of the number of components in the system, thereby simplifying the latter and reducing costs.

Advantageously, the interior of the unit is lined with a metallic film, the metallic film including a metallic material for frequency-selective magnetic shielding, and being capable of magnetically shielding the interior of the unit vis-à-vis at least one predetermined radioelectric frequency.

When the remote control is a remote control of a contactless central unlocking system operating by passive detection, these characteristics permit the prevention of any spurious unlocking of the vehicle and/or of any unwanted start-up of the vehicle engine. In practice, the metallic film magnetically shields the unit vis-à-vis the radioelectric frequency employed by the passive detection system; in other words, the presence of the metallic film prevents the propagation of the radioelectric signal emitted by the remote control to the exterior of the unit.

According to a particular technical embodiment, the data processing equipment includes a web server which hosts a web programing interface, the web programing interface being capable of transmitting, on the communication network for the attention of the electronic device, the first control signal for the locking or unlocking of the vehicle.

Advantageously, the web server stores an information table of reservation time slots for the vehicle, and the web programing interface is capable of extracting temporal data for the command to lock or unlock the vehicle associated with the message, comparing this temporal data with the table, and transmitting or not the first control signal, according to the result of this comparison.

These characteristics permit the provision of a service for the management of access to a single vehicle by a number of users, thus providing, for example, an advantageous application in the context of a vehicle hire service. In addition, these characteristics also permit the configuration, in the web server, of a time range within which the command for the locking or unlocking of the vehicle can effectively be executed.

Advantageously, the web programing interface opens a web page and/or a second programing interface, the web page and/or the second programing interface providing access to the web programing interface.

This characteristic permits the direct transmission by the user to the web programing interface, via a dedicated interface, of a message associated with a command for the locking or unlocking of the vehicle.

Advantageously, the message associated with the command for the locking or unlocking of the vehicle is a text message, specifically a text message employing the Short Message Service protocol, the command associated with the message being either a telephone number of a portable communication device which generated the text message, or an identification number for the vehicle to be controlled, contained within the text message.

These characteristics permit a single portable communication device, associated with a single telephone number, to be able to control the locking or unlocking of one or more vehicle(s).

According to a further aspect, some embodiments are directed to a method for the remote locking and unlocking of a vehicle equipped with central locking, controllable by a remote control, the method being deployed by a locking and unlocking system including an electronic device and data processing equipment, the electronic device being arranged within the vehicle and being able to be linked to the remote control via a data link, the electronic device being linked to the data processing equipment via a communication network. The system also includes a communicator for communicating over the data link and a communicator for communicating over the communication network, The method includes:
receiving, by the data processing equipment, a message associated with a command for the locking or unlocking of the vehicle,
emitting by the data processing equipment, on the communication network for the attention of the electronic device, a first control signal for the locking or unlocking of the vehicle,
receiving, by the electronic device, the first control signal for the locking or unlocking of the vehicle, and
emitting by the electronic device, on the data link for the attention of the remote control, a second control signal for the locking or unlocking of the vehicle.

According to some embodiments, the locking and unlocking system further includes an interfacing unit which is connected between the electronic device and the remote control, and the method further includes receiving by the interfacing unit, the second control signal, and a step for emitting by the interfacing unit, for the attention of the remote control, a third control signal for the locking or unlocking of the vehicle.

According to a particular embodiment of some embodiments, the method further includes emitting, by the interfacing unit, on the data link for the attention of the electronic device, a confirmation signal for the execution of the command for the locking or unlocking of the vehicle, further to receiving, by the interfacing unit of information for the confirmation, the locking or unlocking of the vehicle, transmitted by the remote control.

This permits the delivery of information to the data processing equipment, by the emission by the electronic device of a corresponding confirmation signal on the communication network. This information is intended to confirm or disprove the execution of the locking or unlocking command by the remote control. Thus, in the event of the non-execution of this locking or unlocking command by the remote control, the data processing equipment can advantageously relay the control signal on the communication network, for the attention of the remote control.

### BRIEF DESCRIPTION OF THE FIGURES

Further characteristics and advantages of some embodiments proceed from the following description, which is exemplary only, and is provided with reference to:

FIG. 1, which shows a schematic representation of a system for remotely locking and unlocking a vehicle, according to some embodiments;

FIG. 2, which shows a schematic representation of the system in FIG. 1, according to a first embodiment;

FIG. 3, which shows an organigram representing a method for remotely locking and unlocking a vehicle according to some embodiments, deployed by the system represented in FIG. 2;

FIG. 4, which shows a schematic representation of the system in FIG. 1, according to a second embodiment, wherein the system includes a unit;

FIG. 5, which shows a perspective view of the unit in FIG. 4, wherein the unit includes two servo motors;

FIG. 6, which shows a perspective view of one of the servo motors in FIG. 5, wherein the servo motor is attached to a mounting plate which is fitted to the unit.

### DETAILED DESCRIPTION OF EXEMPLARY EMBODIMENTS

In the following description, the term “electronic device arranged within a vehicle” is understood as any electronic device which is installed in the vehicle, whether permanently or otherwise; this includes, for example, a telematics unit, a wireless telecommunications device such as a cellular telephone or smartphone, a cellular navigation system, a portable computer or else a digital tablet computer, without this list being exhaustive.

The term “portable communication device” is further understood as any wireless telecommunications device, including a cellular telephone or smartphone, a cellular navigation system, a portable computer or else a digital tablet computer, without this list being exhaustive.

The term “microsoftware” is further understood as a series of instructions and data structures which are integrated into IT hardware in order to permit the operation of the latter.

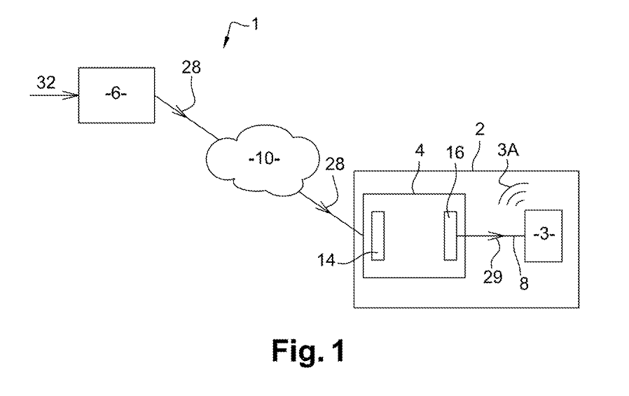

FIG. 1 represents a system 1 for remotely locking and unlocking a vehicle 2. The vehicle 2 is equipped with central locking, which is controllable by a remote control 3. The remote control 3 includes a component for the emission of radioelectric waves 3A, for the radio control of the central locking of the vehicle 2. The emission of radioelectric waves 3A for the control of the central locking is specifically actuated by the manual compression, by a user, of a dedicated button on the remote control 3. The remote control 3 further includes, according to a particular exemplary embodiment, a key or button for the start-up of the engine of the vehicle 2.

The system 1 includes an electronic device 4 and a data processing equipment 6.

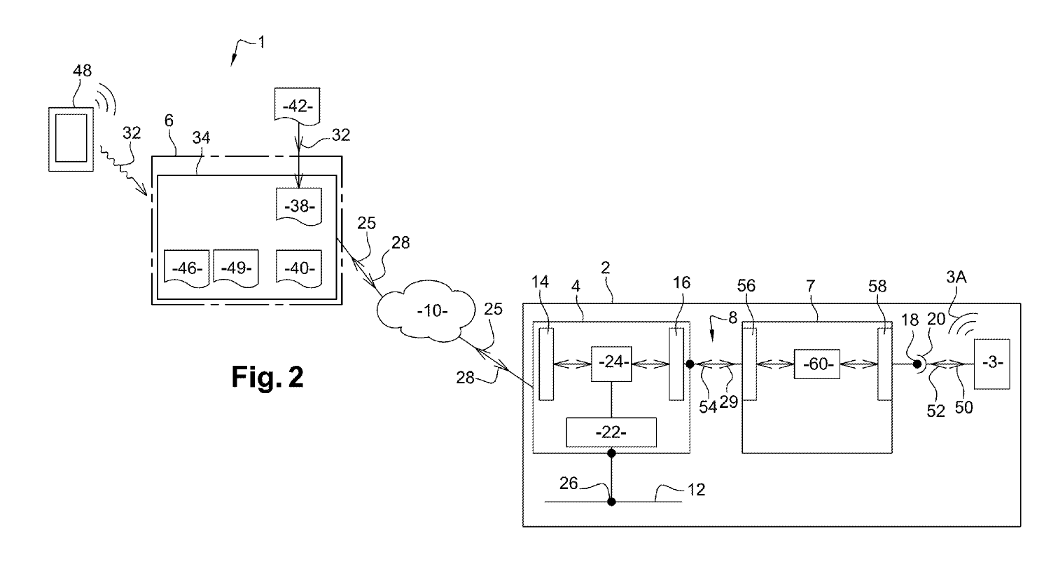

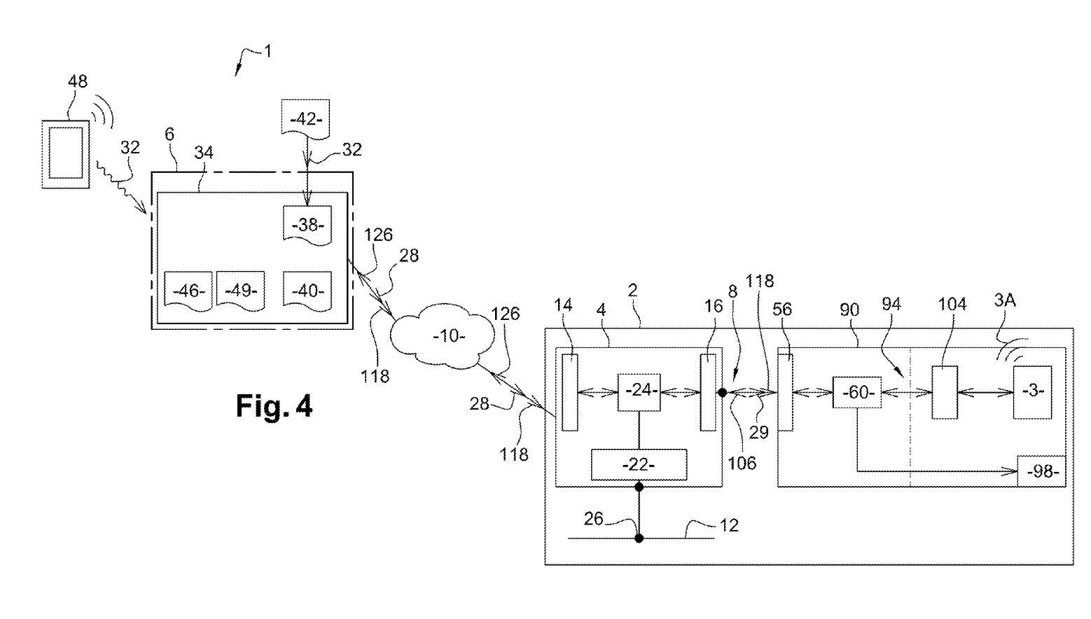

The electronic device 4 is arranged within the vehicle 2. The electronic device 4 is connected firstly to the remote control 3, via a data link 8, and secondly to the data processing equipment 6, via a communication network 10. Advantageously or preferably, as illustrated in FIGS. 2 and 4, the electronic device 4 is further connected to a network 12 on the vehicle 2, for the purposes of interfacing and the exchange of data with the network 12. The electronic device 4 includes communicator 14 on the communication network 10, and communicator 16 on the data link 8.

A system 1 for remotely locking and unlocking the vehicle 2, according to a first embodiment, is represented in FIG. 2.

In this embodiment, the data link 8 is a wired link, and the system 1 further includes an interfacing unit 7. The data link 8 is advantageously or preferably a detachable wired link. More specifically, the data link 8 includes a male connector 18 and a female connector 20, which are mutually connected. One of the male and female connectors 18, 20 is connected to the electronic device 4, the other connector being connected to the remote control 3. The male and female connectors 18, 20 are, for example, connectors of the jack-jack type. That of the male and female connectors 18, 20 which is linked to the remote control 3 is connected thereto, for example, by a cable including a plurality of electrical strands which are soldered to certain key points on the printed circuit board of the remote control 3 including, for example, an electrical ground, certain switches or buttons, or else electric power supply terminals.

The communication network 10 is equipped with a private or wide-area communication infrastructure which permits the connection of, or access to, communication facilities of the server type and/or databases and/or electronic communication devices. In a conventional manner, the communication infrastructure constitutes a wireless network, or a network including a wired element and a wireless element. According to a particular embodiment, the communication network 10 is designed as a cellular network of the GPRS type (for “General Packet Radio Service”) or UMTS type (for “Universal Mobile Telecommunications System”). As a variant, the communication network 10 can be designed as a network of the Internet type which includes, for example, a network segment which is compliant with the GPRS standard or with the UMTS standard.

The electronic device 4 is connected to a network 12 of the vehicle 2 via a network interface 22. The electronic device 4 is configured, for example, in the form of an independent unit which is connected to the network 12 of the vehicle, for example in the form of a telematics unit. As a variant, the electronic device 4 may be integrated in a pre-existing element of the vehicle 2 within which it is arranged, such as, for example, a dashboard, and is thus connected to the network 12 of the vehicle. The electronic device 4 includes data memorization and processing device 24. The data memorization and processing device 24 are connected to the communicator 14 on the communication network 10, to the communicator 16 on the data link 8, and to the network interface 22. Advantageously or preferably, as illustrated in FIG. 2, the electronic device 4 is capable, on the basis of a confirmation signal 54 for the execution of a command for the locking or unlocking of the vehicle 2 received from the interfacing unit 7, of generating and emitting a corresponding signal 25 on the communication network 10, for the attention of the data processing equipment 6, as described hereinafter.

The network interface 22 is equipped with the requisite electrical and electronic power ratings and protocols for interaction with the network 12 of the vehicle, specifically for the retrieval of data circulating in the network 12 of the vehicle. The network interface 12 is configured, for example, in the form of a wireless antenna or in the form of a connector which is designed for connection to the network 12 of the vehicle in a wired arrangement. According to a first example, the vehicle 2 includes a plurality of electronic control units, which are not represented on the figures, for reasons of clarity. The electronic control units are interconnected by the network 12 of the vehicle 2, and are configured for the control of various sub-systems of the vehicle 2. The network 12 of the vehicle is, for example, a CAN bus (for “Controller Area Network”), to which the electronic control units are connected. According to a second example, the network 12 of the vehicle may be an electric power supply network. The network 12 is connected to an electric power source of the vehicle 2 such as, for example, a vehicle battery. In these two examples, the network interface 22 may be a connector, which is linked by wires to a connector 26, which is in turn connected to the network 12 of the vehicle. In the first example, the connector 26 is, for example, an OBD connector (for “On-Board Diagnostic”).

The data memorization and processing device 24, on the basis of a first control signal 28 for the locking and unlocking of the vehicle 2 received from the data processing equipment 6, are capable of generating a second control signal 29 for the locking and unlocking of the vehicle 2, which is intended for transmission to the remote control 3. The data memorization and processing device 24 are constituted, for example, of at least one processor, associated with at least one memory. The memory stores, for example, a microsoftware, which is not represented on the figures for reasons of clarity.

The communicator 14 on the communication network 10 are capable of receiving the first control signal 28 from the data processing equipment 6, via the communication network 10, as will be described in detail hereinafter. Advantageously or preferably, the communicator 14 are also capable of transmitting messages or signals on the communication network 10, for the attention of the data processing equipment 6.

The communicator 14 include, for example, a data transmitter-receiver on a cellular communication network, such as an antenna.

The communicator 16 on the data link 8 are designed to transmit, on the data link 8 for the attention of the remote control 3, the second control signal 29 for the locking or unlocking of the vehicle 2, as will be described in detail hereinafter. Advantageously or preferably, the communicator 16 are also capable of receiving signals or messages from the remote control 3, via the data link 8. The communicator 16 include, for example, a data transmitter-receiver on a wired data link such as, for example, a physical signal interface.

The data processing equipment 6 is capable of emitting, further to the reception of a message 32 associated with a command for the locking or unlocking of the vehicle 2, on the communication network 10 for the attention of the electronic device 4, the first control signal 28 for the locking or unlocking of the vehicle, such that the electronic device 4 transmits the corresponding second control signal 29 to the remote control 3. Advantageously or preferably, the data processing equipment 6 is further capable of processing information transmitted by the electronic device 4.

The data processing equipment 6 includes a web server 34.

The web server 34 hosts a web programing interface 38. Advantageously or preferably, as illustrated in FIG. 2, the web server 34 additionally stores an information table 40 of reservation time slots for the vehicle 2. Also advantageously or preferably, the web server 34 also stores a correlation table 46 of telephone numbers and vehicle identifiers. Each telephone number is associated in the table 46 with one or more vehicle identifier(s). For example, in the particular exemplary embodiment shown in FIG. 2, a telephone number for a portable communication device 48 is associated in the table 46 with an identifier of the vehicle 2. Identifiers of the vehicles are, for example, the registration number thereof, or digital key codes. Advantageously or preferably, the web server 34 additionally stores a table 49 of user identifiers. A table 49 of this type specifically permits the definition of customized profiles for different users of the system 1. Different rights of access can thus be defined for different users, within the table 49, by the potential association thereof with the information contained in the table 40 or in the table 46.

The web programing interface 38 is capable of transmitting, on the communication network 10 for the attention of the electronic device 4, the first control signal 28 for the locking or unlocking of the vehicle. Advantageously or preferably, the web programing interface 38 is further designed to extract a temporal datum for the command for the locking or unlocking of the vehicle 2 associated with the message 32, to compare this temporal datum with the information table 40 of reservation time slots for the vehicle 2, and to transmit or not the first control signal 28, according to the result of this comparison. The temporal datum is, for example, a time-stamp data element corresponding to the date and time of emission of the message 32.

The web programing interface 38 opens a web page 42. The web page 42 provides access to the web programing interface 38, in order to permit a user to transmit to the web programing interface 38 the message 32 associated with a command for the locking or unlocking of the vehicle 2. As a variant, or additionally, the web programing interface 38 opens a second programing interface, which is not represented in the figures, which provides access to the web programing interface 38 in order to permit a user to transmit the message 32 to the web programing interface 38. The second programing interface is, for example, a programing interface of the REST type (for “Representational State Transfer”). Advantageously or preferably, access to the web page 42 or to the second programing interface is protected by a secure authentication protocol.

The interfacing unit 7 is connected between the electronic device 4 and the remote control 3. The interfacing unit 7 is capable of receiving the second control signal 29 for the locking or unlocking of the vehicle 2, and of emitting, for the attention of the remote control 3, a third control signal 50 for the locking or unlocking of the vehicle 2. The interfacing unit 7 is configured for the conversion and transmission of input-output signals from the remote control 3 and the electronic device 4, from one to another and reciprocally. Advantageously or preferably, as illustrated in FIG. 2, the interfacing unit 7 is further configured for the reception from the remote control 3 of information 52 for the confirmation of the locking or unlocking of the vehicle 2, and for the emission, on the data link 8 for the attention of the electronic device 4, of a confirmation signal 54 for the execution of the command for the locking or unlocking of the vehicle 2. The operation of the interfacing unit 7 will be described in detail hereinafter.

The interfacing unit 7 includes communicator 56 with the electronic device 4, communicator 58 with the remote control 3, and data memorization and processing device 60.

The communicator 56, 58 are each connected to the data memorization and processing device 60. The communicator 56, 58 each include, for example, a data transmitter-receiver on a wired data link such as, for example, a physical signal interface.

The data memorization and processing device 60 are capable of generating the third control signal 50 on the basis of the second control signal 29 received. The data memorization and processing device 60 are further capable of generating the confirmation signal 54 for the execution of the command for the locking or unlocking of the vehicle 2, on the basis of the information 52 for the confirmation of the locking or unlocking of the vehicle 2. The data memorization and processing device 60 include, for example, at least one processor associated with at least one memory.

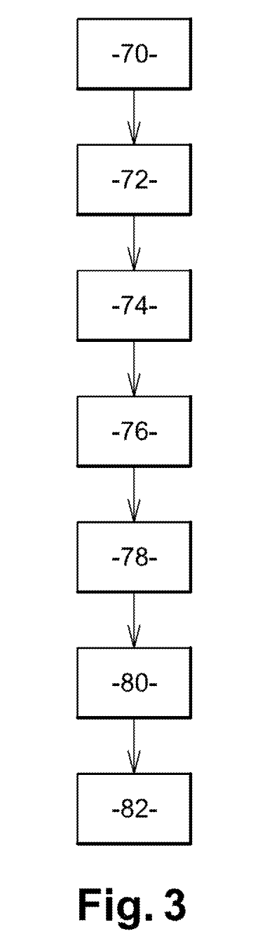

The method for remotely locking and unlocking the vehicle 2, deployed by the locking and unlocking system 1 represented in FIG. 2, will now be described with reference to FIGS. 1 to 3.

Initially, it is assumed that a message 32 associated with a command for the locking or unlocking of the vehicle 2 is emitted by a user.

More specifically, the message 32 can be, for example, a text message emitted by a portable communication device 48 of the user. The text message is, for example, compliant with the SMS protocol (for “Short Message Service”) and is, for example, emitted to a dedicated telephone number on a dedicated telephone server, which is not represented on the figures, for reasons of clarity. In the event that the message 32 is a text message emitted by a portable communication device 48, the command associated with the message 32 is either the telephone number of the device 48, transmitted to the web server 34 by the telephone operator of the device 48 at the time of reception of the message 32, or an identification number for the vehicle 2, contained in the body of the text message. The identification number of the vehicle 2 is, for example, the registration number of the vehicle. As a variant, the identification number of the vehicle 2 may be a digital key code corresponding to the vehicle 2. The command is the telephone number of the device 48, when this telephone number is associated with a single vehicle, in this case the vehicle 2, in the correlation table 46. The command is the identification number of the vehicle 2, contained in the body of the text message, when the telephone number of the device 48 is associated with a number of vehicles in the correlation table 46.

The message 32 may also be a control instruction for the locking or unlocking of the vehicle 2, transmitted via a web page 42 or via a programing interface, for example of the REST type.

During an initial step 70, the data processing equipment 6 receives the message 32 associated with the command for the locking or unlocking of the vehicle 2.

More specifically, according to the particular embodiment shown in FIG. 2, if the message 32 is a text message emitted by a portable communication device 48, the web server 34 receives the message 32 and verifies the presence of the telephone number of the device 48 in the correlation table 46. If the telephone number of the device 48 is present in the correlation table 46, the following step 72 is initiated upon the completion of the initial step 70. If not, the process is interrupted.

If the message 32 is a control instruction for locking or unlocking transmitted via a web page 42 or via a programing interface, the web programing interface 38 receives the message 32 during step 70.

During a following step 72, the data processing equipment 6 generates, on the communication network 10 for the attention of the electronic device 4, a first control signal 28 for the locking or unlocking of the vehicle 2. More specifically, according to the particular embodiment represented in FIG. 2, the web programing interface 38 extracts a temporal datum for the command for the locking or unlocking of the vehicle 2 associated with the message 32, then compares this temporal datum with the information table 40 of reservation time slots for the vehicle 2. If the result of this comparison indicates that the temporal datum falls within a reservation time slot which corresponds to an identifier for the user, the web programing interface 38 transmits the first control signal 28 to the electronic device 4 via the communication network 10. If not, the process is interrupted. In this case, if the message 32 is a text message emitted by a portable communication device 48, the data processing equipment 6 can, for example, transmit an information message to the portable communication device 48 from which this text message has originated.

During a subsequent step 74, the electronic device 4 receives the first control signal 28 for the locking or unlocking of the vehicle 2. More specifically, according to the particular exemplary embodiment represented in FIG. 2, the communicator 14 on the network 10 receive the first control signal 28. Upon the completion of step 74, the communicator 14 then transmit the first control signal 28 to the data memorization and processing device 24.

During a subsequent step 76, the electronic device 4 emits, on the data link 8 for the attention of the remote control 3, a second control signal 29 for the locking or unlocking of the vehicle 2. More specifically, according to the particular exemplary embodiment represented in FIG. 2, the data memorization and processing device 24 generate the second control signal 29 on the basis of the first control signal 28 received, then transmit this second control signal 29 to the communicator 16 on the data link 8. The communicator 16 then emit the second control signal 29 on the wired link 8.

Advantageously or preferably, the method includes a subsequent step 78, during which the interfacing unit 7 receives the second control signal 29. More specifically, according to the particular exemplary embodiment represented in FIG. 2, the communicator 56 with the electronic device 4 receive the second control signal 29. Upon the completion of step 78, the communicator 56 then transmit the second control signal 29 to the data memorization and processing device 60.

Advantageously or preferably, the method includes a subsequent step 80, during which the interfacing unit 7 emits, for the attention of the remote control 3, a third control signal 50 for the locking or unlocking of the vehicle 2. More specifically, according to the particular exemplary embodiment represented in FIG. 2, the data memorization and processing device 60 generate the third control signal 50 on the basis of the second control signal 29 received, then transmit this third control signal 50 to the communicator 58 with the remote control. The communicator 58 then emit the third control signal 50 on the wired link 8.

Upon the completion of step 76 or step 80, the remote control 3 receives a control signal 29, 50 for the locking or unlocking of the vehicle 2. The remote control 3 then emits radioelectric waves 3A for the attention of the central locking system of the vehicle 2, for the locking or unlocking of the vehicle 2. Advantageously or preferably, the remote control 3 then emits, on the data link 8, confirmation information 52 for the locking or unlocking of the vehicle 2.

Advantageously or preferably, the method includes a final step 82, during which the interfacing unit 7 receives confirmation information 52 for the locking or unlocking of the vehicle 2. The interfacing unit 7 then emits, on the data link 8 for the attention of the electronic device 4, a confirmation signal 54 for the execution of the command for the locking or unlocking of the vehicle 2. More specifically, according to the particular exemplary embodiment represented in FIG. 2, the communicator 58 with the remote control 3 receive the information 52, then transmit this information 52 to the data memorization and processing device 60. The data memorization and processing device 60 generate the confirmation signal 54 on the basis of the information 52 received, then transmit this confirmation signal 54 to the electronic device 4 on the data link 8. Upon the completion of this final step 82, the electronic device 4 generates a confirmation signal 25 corresponding to the confirmation signal 54 for the execution of the command for the locking or unlocking of the vehicle 2, and emits this signal 25 on the communication network 10 for the attention of the data processing equipment 6.

FIGS. 4 to 6 illustrate a system 1 for remotely locking and unlocking the vehicle 2 according to a second embodiment, in which elements analogous to the first embodiment, described above with reference to FIG. 2, are identified by identical reference numbers and, accordingly, are not described again.

In this second embodiment, the system 1 no longer includes an interfacing unit 7, but includes a unit 90 which is connected to the electronic device 4. The unit 90 can be electrically powered by the electronic device 4 and is designed to be arranged, for example, within the glove compartment of the vehicle 2.

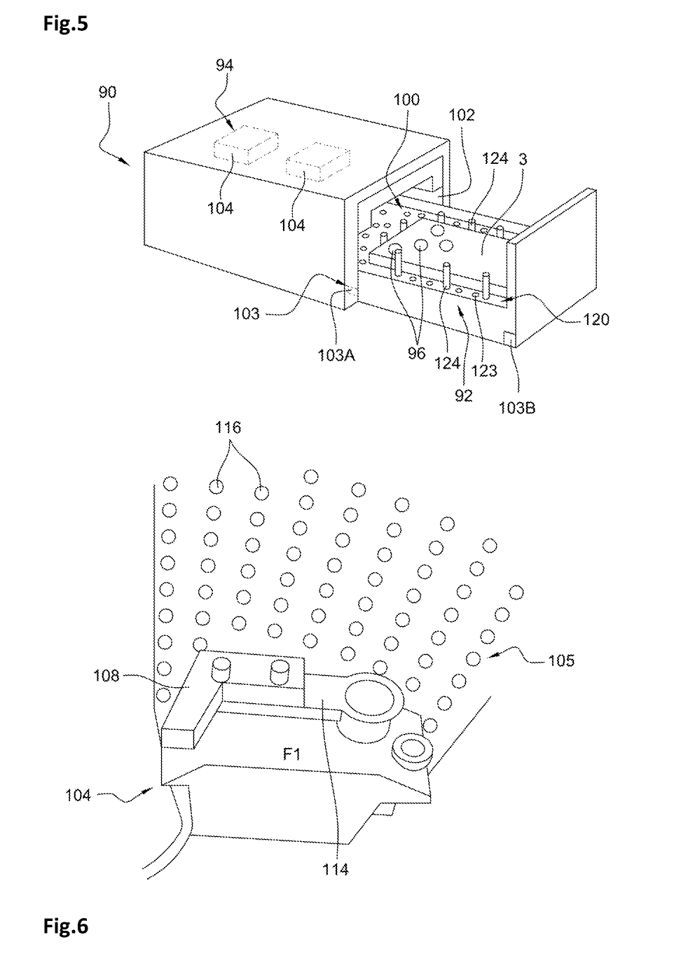

The unit 90 includes communicator 56 with the electronic device 4. The unit 90 further includes a reception compartment 92 for the remote control 3, and electromechanical device 94 for the actuation of at least one button 96 for the locking or unlocking of the vehicle 2, arranged on the remote control 3. Advantageously or preferably, the unit 90 further includes a bolt 98, together with device 100 for the positioning and maintenance in position of the remote control 3 within the reception compartment 92. Further advantageously or preferably, the unit 90 includes a metallic film 102. The interior of the unit 90 is lined with the metallic film 102, as illustrated in FIG. 5.

The reception compartment 92 is installed so as to be moveable, between a position of open access to the remote control 3, illustrated in FIG. 5, and a closed position, in which the remote control 3 is no longer accessible from the exterior of the unit 90.

Advantageously or preferably, the unit 90 further includes a device 103 for the detection of the closure of the compartment 92, and a device for the detection of the presence and the correct positioning of the remote control 3 within the compartment 92, the latter device not being represented in the figures, for reasons of clarity. The device 103 is, for example, an end-of-travel electrical contactor, including a first part 103A, which is affixed to an internal surface of the unit 90, and a second part 103B, affixed to an external surface of the compartment 92, as illustrated in FIG. 5. The device for the detection of the presence and the correct positioning of the remote control 3 within the compartment 92 is, for example, a magnetic contactor, typically a magnet.

The electromechanical actuator 94 are capable of receiving the second control signal 29, and of mechanically actuating at least one button 96 for the locking or unlocking of the vehicle 2, arranged on the remote control 3, according to the value of this signal 29. The electromechanical actuator 94 include data memorization and processing device 60. Advantageously or preferably, the electromechanical device 94 further include at least one servo motor 104. In the exemplary embodiment represented in FIG. 5, the electromechanical device 94 include two servo motors 104. Further advantageously or preferably, the electromechanical device 94 additionally include a mounting plate 105 for the servo motors 104, as illustrated in FIG. 6.

The data memorization and processing device 60 are capable of receiving the second control signal 29, and of controlling the servo motors 104 according to the value of this signal 29. The data memorization and processing device 60 are further capable of generating a signal 106 for the relay of information for the attention of the data processing equipment 6, as will be described hereinafter. The data memorization and processing device 60 can be connected to the device 103 for the detection of the closure of the compartment 92, and/or to the device for the detection of the presence and the correct positioning of the remote control 3 within the compartment 92. In this case, the signal 106 for the relay of information includes, for example, indicative information of the correct closure of the compartment 92 and/or indicative information of the presence and the correct position of the remote control 3 within the compartment 92. The data memorization and processing device 60 include, for example, an electronic control unit associated with at least one memory.

Each servo motor 104 is connected to the electronic unit of the data memorization and processing device 60, in the interior of the unit 90. Each servo motor 104 is arranged opposite the reception compartment 92, on the side of the buttons 96 for the locking or unlocking of the remote control 3. Each servo motor 104 is moveable between two positions, a resting position and an actuation position for one of the buttons 96 for the locking or unlocking of the vehicle 2. Advantageously or preferably, as illustrated in FIG. 6, each servo motor 104 is equipped with an actuation arm 108, arranged opposite one of the locking or unlocking buttons 96 when the compartment 92 is in its closed position. Accordingly, the arm 108 is moveable between a resting position and an actuation position for the button 96, in the direction of the arrow F1, as represented in FIG. 6. The arm 108 is designed, in the actuation position, to mechanically actuate the button 96, thereby permitting the locking or unlocking of the vehicle 2.

Each arm 108 is, for example, connected to the corresponding servo motor 104 by a connecting vane 114 which is permanently attached to the servo motor 104. Each arm 108 is then secured in a detachable manner to the corresponding connecting vane 114. This permits the straightforward replacement of an arm 108 of a given size and angle with another arm 108 of a different size and/or angle. Moreover, advantageously, the stroke and/or the speed of each arm 108 are parameterizable data within the data memorization and processing device 60. These parameters can be, for example, remotely configured by a user, then transmitted to the data memorization and processing device 60 via the communication network 10. The electromechanical actuator 94 are thus easily adaptable to the format of a given remote control 3, thereby ensuring the compatibility of the system with any format of remote control 3.

Advantageously or preferably, each servo motor 104 is additionally equipped with a pressure sensor which is designed to measure the pressure applied to the button 96 during the actuation of the button 96 by the arm 108. A pressure sensor of this type is not represented on the figures, for reasons of clarity. A pressure sensor of this type is, for example, a resistive sensor, arranged within the servo motor 104 and designed to measure the electric current consumed by the servo motor 104 for the movement of the arm 108. In practice, when the arm 108 of the servo motor 104 compresses the button 96, a demand for electric current is generated in the servo motor 104. The pressure measurement executed by the sensor is thus an indirect measurement. As a variant, the pressure sensor is, for example, a piezoelectric sensor, in which case the pressure measurement executed by the sensor is a direct measurement. Thus, information for the confirmation of the locking or unlocking of the vehicle 2 can be obtained by a comparison of the pressure value measured by the pressure sensor with a predetermined threshold pressure value. This information for the confirmation of locking or unlocking can be integrated, for example, in the signal 106 for the relay of information.

The mounting plate 105 is provided with a plurality of holes 116. Each servo motor 104 is attached in a detachable manner to the plate 105, by fixing devices which pass through one or more holes 116. The number of holes 116 and the mutual spacing of the holes 116 in the plate 105 are such that the easy and accurate repositioning of the servo motors 104 on the mounting plate 105 is permitted, in the interests of the easy adaptation of the electromechanical actuator 94 to different formats of remote control 3 and different potential arrangements of buttons 96. This ensures the compatibility of the system with any existing format of remote control 3. The spacing between two adjacent holes 116 in the plate 105 is, for example, substantially equal to 3 mm.

The bolt 98 is connected to the electronic unit of the data memorization and processing device 60, as illustrated in FIG. 4. The bolt 98 is designed for the mechanical locking or unlocking of the reception compartment 92, when the compartment 92 is in its closed position. To this end, the bolt 98 includes, for example, a mechanical locking element, such as a locking pin, connected to an electric motor; these two elements are not represented on the figures for reasons of clarity. The electric motor is, for example, connected to the data memorization and processing device 60. The electronic unit is capable of receiving a control signal 118 for the mechanical locking or unlocking of the reception compartment 92, and of controlling the bolt 98 according to the value of this signal 118.

An exemplary embodiment of the device 100 for the positioning and maintenance in position of the remote control 3 is represented in FIG. 5. In this example, the device 100 for positioning and maintenance in position include a bearing plate 120 for the remote control 3.

The bearing plate 120 includes a plurality of holes 123, together with studs which are plugged into all or some of these holes 123. The studs are, for example, detachable, and may be installed or removed by a user. Moreover, these studs are of adjustable height. Accordingly, certain of these studs, which are the studs 124 illustrated in FIG. 5, may be arranged such that they project from the plate 120 to their maximum height. These studs 124 thus constitute studs for the delimitation of the remote control 3. Other studs are arranged in certain holes 123 below the remote control 3, and project from the plate 120 to a reduced height. The latter studs, which are particularly advantageous where the remote control 3 is of convex design, permit the remote control 3 to be securely maintained in position.

Studs of this type, by their detachable design and their adjustable height, permit the bearing plate 120 to be configured with a reconfigurable design, thereby permitting the exact accommodation of the shape of any remote control 3. Thus, regardless of the shape of the remote control 3, the latter is securely supported by the bearing plate 120. This ensures the secure engagement of the arm 108 of each servo motor 104 with the corresponding button 96 of the remote control 3, thus preventing any movement or tilting of the remote control 3 associated with the engagement.

In an unrepresented variant, the device 100 for positioning and maintenance in position include a plate for the chocking and maintenance in position of the remote control 3. The plate includes, for example, a recess. The plate is designed to accommodate, in its recess, a proportion of the remote control 3, and to maintain the remote control 3 in position within the compartment 92.

The metallic film 102 is, for example, adhered to the interior of the unit 90. The metallic film 102 is includes a frequency-selective magnetic shielding metallic material. A material of this type is, for example, a metamaterial of the metal-dielectric composite type. Advantageously, a regular arrangement of pre-cut patterns in the metal such as, for example, slots, may be included in the metallic film 102. Moreover, localized capacitive and inductive elements may be included in the metallic film 102, in addition to the pre-cut patterns. These various patterns and elements permit the achievement of the optimum frequency-selective property of the metallic film 102, and are also conducive to the achievement of dimensions for the film 102 which are compatible with a unit 90 which is designed, for example, to be arranged in a glove compartment of the vehicle 2.

The metallic film 102 is designed for the magnetic shielding of the interior of the unit 90 vis-à-vis at least one predetermined radioelectric frequency. In a preferred exemplary embodiment, the metallic film 102 is designed for the magnetic shielding of the interior of the unit 90 vis-à-vis a radioelectric frequency of value substantially equal to 125 kHz. This value corresponds to a standardized radioelectric frequency value employed in a passive detection system using a contactless remote control key 3. A system of this type employed in a vehicle 2 includes, in addition to the remote control key 3, low-frequency antennae which are integrated, for example, in the door handles of the vehicle and in the interior of the latter. A system of this type permits the unlocking of the vehicle 2 and/or the start-up of the engine of the latter when a user, carrying the remote control key 3, stands within a distance which is less than a predetermined threshold distance to the vehicle 2. No execution by the user of a manual action on the remote control is required in order to unlock the vehicle and/or to start up the engine of the vehicle, as the remote control 3 periodically emits the radioelectric signal at a standardized frequency, for example of a value substantially equal to 125 kHz.

As a variant, the material of the metallic film 102 is selected such that the latter acts as a high-pass filter, filtering out all the radioelectric frequencies which lie below a predetermined threshold frequency. The predetermined threshold frequency is, for example, of a value substantially equal to 400 MHz.

In operation, the method for remotely locking and unlocking the vehicle 2 according to some embodiments, deployed by the system 1 represented in FIGS. 4 to 6, proceeds as follows.

Initially, it is assumed that the remote control 3 is installed in the reception compartment 92 of the unit 90. In the exemplary embodiment in which the remote control 3 is a contactless remote control key 3, the presence of the metallic film 102 on the interior of the unit 90 prevents any spurious unlocking of the vehicle 2 and/or any unwanted start-up of the engine of the vehicle 2. In practice, the metallic film 102 magnetically shields the unit 90 vis-à-vis the radioelectric frequency employed by the passive detection system; in other words, the presence of the metallic film 102 prevents the propagation of the radioelectric signal emitted by the remote control key 3 to the exterior of the unit 90.

Steps 70 to 76 of the method deployed by the system according to this second embodiment are identical to steps 70 to 76 described above with reference to the method deployed by the system according to the first embodiment, and consequently will not be described in any further detail here.

During a subsequent step, the unit 90 receives the second control signal 29. More specifically, the electromechanical actuator 94 receive the second control signal 29. More specifically again, according to the particular exemplary embodiment represented in FIG. 4, the communicator 56 with the electronic device 4 receive the second control signal 29. Upon the completion of this step, the communicator 56 then transmit the second control signal 29 to the data memorization and processing device 60.

During a subsequent step, the electromechanical actuator 94 mechanically actuate at least one button 96 for the locking or unlocking of the vehicle 2, arranged on the remote control 3, according to the value of the second control signal 29. More specifically, according to the particular exemplary embodiment represented in FIG. 4, the electronic unit of the data memorization and processing device 60 actuates one of the servo motors 104, according to the value of the second control signal 29. This servo motor 104 then moves from its resting position to its position for the actuation of one of the buttons 96 for the locking or unlocking of the vehicle 2. In the preferential exemplary embodiment represented in FIG. 6, the servo motor 104 thus drives its associated arm 108 from its resting position to its actuation position, in the direction of the arrow F1, as represented on FIG. 6. The arm 108 thus mechanically actuates the button 96. Upon the completion of this step, the remote control 3 emits radioelectric waves 3A for the attention of the central locking system of the vehicle 2, for the locking or unlocking of the vehicle 2. Advantageously or preferably, when the second signal 29 is a control signal for the locking of the vehicle 2, the electronic unit only actuates the servo motor 104 for the locking of the vehicle 2 if the compartment 92 has been detected in its closed position, for example by the closure detection device 103, and if the presence of the remote control 3 has been detected in the compartment 92, for example by the device for the detection of the presence and the correct positioning of the remote control 3 within the compartment 92.

Advantageously or preferably, in the exemplary embodiment in which the unit 90 includes a bolt 98, the method includes a subsequent step, during which the electronic unit of the data memorization and processing device 60 receives a control signal 118 for the mechanical locking or unlocking of the reception compartment 92. The electronic unit then actuates the bolt 98 according to the value of this signal 118. A control signal 118 of this type for locking or unlocking is, for example, transmitted by the equipment 6 to the electronic device 4, via the communication network 10, and thereafter by the electronic device 4 to the data memorization and processing device 60. A signal 118 of this type is derived, for example, from a message which is analogous to the message 32 associated with a command for the locking or unlocking of the vehicle 2, and is, for example, emitted in the same manner as this message 32. Upon the completion of this step, the bolt 98 locks or unlocks the reception compartment 92. When the signal 118 is a control signal for unlocking, the electronic unit actuates the bolt 98 such that the latter unlocks the reception compartment 92. A user of the vehicle 2, who has previously unlocked the vehicle 2 as described above, can then access the remote control 3 contained in the reception compartment 92. The user can then retrieve the remote control 3, for example in order to start up the vehicle 2.

Advantageously or preferably, the method further includes a final step, during which the data memorization and processing device 60 generate a signal 106 for the relay of information. The unit 90 then emits this signal 106 on the data link 8, for the attention of the electronic device 4. The signal 106 for the relay of information includes, for example, indicative information for the correct closure of the compartment 92 and/or indicative information for the presence and the correct positioning of the remote control 3 within the compartment 92 and/or information for the confirmation of the locking or unlocking of the vehicle 2. Upon the completion of this final step, the electronic device 4 generates a signal 126 corresponding to the signal 106 for the relay of information, and sends this signal 126 on the communication network 10, for the attention of the equipment 6.

One advantageous application of a locking and unlocking system and method of this type according to some embodiments involves, for example, an owner of a vehicle 2 who wishes to loan or lease their vehicle to a user. By a text message, of a text message type according to the SMS protocol, or a command issued via a web page or a programing interface, the user can remotely unlock the vehicle 2, gain access thereto, retrieve the remote control key 3 which is present in the vehicle, start up the engine of the vehicle and use the vehicle as normal. When the user leaves the vehicle 2, they replace the remote control key 3 in the position where they found it. They can then transmit a text message, or a command via a web page or a programing interface, in order to lock the vehicle 2.

Accordingly, an application of this type advantageously permits the owner of a vehicle 2 to loan the vehicle to a user, without physically delivering the keys of the vehicle to the latter. Moreover, the user can access the vehicle 2 without being in possession of the key to the latter, and only if authorized to do so by the owner.

The system for remotely locking and unlocking a vehicle according to some embodiments provides a number of advantages:
the system advantageously adapts to all vehicles equipped with central locking which is controllable by a remote control, in other words to a large number of vehicles;
the system requires no complex modification of the vehicle, only the connection of the electronic device to the remote control being required;
the system imposes no limitation upon the number of callers who are authorized to lock/unlock the vehicle, when the message associated with the command to this effect is a text message, provided that the telephone numbers of these callers are logged in the correlation table of telephone numbers and vehicle identifiers;
the system permits a single portable communication device, associated with a single telephone number, to control the locking or unlocking of a number of vehicles, by the entry of the identification number of the vehicle to be controlled in each text message transmitted.

In the claims, the term “including” does not exclude other elements.

1. A system for remotely locking and unlocking a vehicle equipped with central locking controlled via a remote control, the system comprising:
an electronic device and data processing equipment, the electronic device configured to be arranged within the vehicle and being able to be linked to the remote control via a data link, the electronic device being linked to the data processing equipment via a communication network;
a communicator for communicating over the data link; and
a communicator for communicating over the communication network;
wherein the data processing equipment is able, following the reception of message associated with a command for locking or unlocking the vehicle, to emit, on the communication network for the attention of the electronic device, a first signal for controlling the locking or unlocking of the vehicle, such that the electronic device sends to the remote control a second corresponding control signal, so as to lock or unlock the vehicle.

2. The system as claimed in claim 1, further comprising an interfacing unit which is connected between the electronic device and the remote control, the unit being designed to receive the second control signal and to emit, for the attention of the remote control, a third control signal for the locking or unlocking of the vehicle.

3. The system as claimed in claim 2, wherein the interfacing unit is configured for the reception, from the remote control, of information for the confirmation of the locking or unlocking of the vehicle, further to the reception by the remote control of the third control signal, and for the emission, on the data link for the attention of the electronic device, of a confirmation signal for the execution of the command for the locking or unlocking of the vehicle.

4. The system as claimed in claim 1, wherein the data link is a wired link, specifically a detachable wired link comprising a male connector and a female connector.

5. The system: as claimed in claim 1, further comprising a unit which is connected to the electronic device, the unit including a reception compartment, for the remote control and an electromechanical device for the actuation of at least one locking or unlocking button of the vehicle, arranged on the remote control, the electromechnical device being designed for the reception of the second control signal and for the mechanical actuation of the locking or unlocking button, as a function of the value of this control.

6. The system as claimed in claim 5, wherein the unit further includes a bolt, which is capable of the mechanical locking or unlocking of the reception compartment, the reception compartment being installed so as to be moveable between a position of open access to the remote control, and a closed position, in which the remote control is no longer accessible from the exterior of the unit, the bolt being capable of mechanically locking or unlocking the reception compartment, when the compartment is in its closed position.

7. The as claimed in claim 6, wherein the electromechanical actuation device of at least one locking or unlocking button of the vehicle comprise at least one servo motor, which is moveable between two positions, and an electronic control unit for the movement of the at least one servo motor, the at least one servo motor being equipped with an actuating arm, arranged opposite the or one of the locking or unlocking button(s) of the vehicle, and capable, in one of the two positions of the servo motor, of mechanically actuating the button.

8. The system as claimed in claim 7, wherein the at least one servo motor is equipped with a pressure sensor which is capable of measuring the pressure applied to the locking or unlocking button of the vehicle during the actuation of this button by the arm of the servo motor.

9. The system as claimed in 7, wherein the electronic control unit for the movement of the at least one servo motor is further connected to the bolt, and is capable of controlling the bolt so as to mechanically lock or unlock the reception compartment.

10. The system as claimed in claim 5, wherein the interior of the unit is lined with a metallic film, the metallic film being constituted of a metallic material for frequency-selective magnetic shielding, and capable of magnetically shielding the interior of the unit vis-à-vis at least one predetermined radioelectric frequency.

11. The system as claimed in claim 1, wherein the data processing equipment includes a web server which hosts a web programing interface, the web programing interface being capable of transmitting, on the communication network for the attention of the electronic device, the first control signal for the locking or unlocking of the vehicle.

12. The system as claimed in claim 11, wherein the web server stores an information table of reservation time slots for the vehicle, and the web programing interface is capable of extracting temporal data for the command to lock or unlock the vehicle associated with the message,, comparing this temporal data with the table, and transmitting or not the first control signal according to the result of this comparison.

13. A method for remotely locking and unlocking a vehicle equipped with central locking controlled via a remote control, the method being deployed by a locking and unlocking system that includes an electronic device and a data processing equipment, the electronic device being arranged within the vehicle and being able to be linked to the remote control via a data link, the electronic device being linked to the data processing equipment via a communication network, and including a communicator for communicating over the data link and a communicator for communicating over the communication network, the method includes:
receiving, by the data processing equipment, a message associated with a command for the locking or unlocking of the vehicle,
emitting by the data processing equipment, on the communication network for the attention of the electronic device, a first control signal for the locking or unlocking of the vehicle,
receiving, by the electronic device, the first control signal for the locking or unlocking of the vehicle, and
emitting by the electronic device, on the data link for the attention of the remote control, a second control signal for the locking or unlocking of the vehicle.

14. The method as claimed in claim 13, wherein the locking and unlocking system further an interfacing unit which is connected between the electronic device and the remote control, and wherein the method further includes receiving by the interfacing unit the second control signal; and emitting by the interfacing unit), for the attention of the remote control, a third control signal for the locking or unlocking of the vehicle.

15. The method as claimed in claim 14, further including emitting by the interfacing unit, on the data link for the attention of the electronic device a confirmation signal for the execution of the command for the locking or unlocking of the vehicle, further to the reception by the interfacing unit of information for the confirmation of the locking or unlocking of the vehicle, transmitted by the remote control.

16. The system as claimed in claim 2, wherein the data link is a wired link, specifically a detachable wired link comprising a male connector and a female connector.

17. The system as claimed in claim 3, wherein the data link is a wired link, specifically a detachable wired link comprising a male connector and a female connector.

18. The system as claimed in claim 5, wherein the electromechanical actuation device of at least one locking or unlocking button of the vehicle comprise at least one servo motor, which is moveable between two positions, and an electronic control unit for the movement of the at least one servo motor, the at least one servo motor being equipped with an actuating arm, arranged opposite the or one of the locking or unlocking button(s) of the vehicle, and capable, in one of the two positions of the servo motor, of mechanically actuating the button.

19. The system as claimed in claim 8, wherein the electronic control unit for the movement of the at least one servo motor is further connected to the bolt, and is capable of controlling the bolt so as to mechanically lock or unlock the reception compartment.

20. The system as claimed in claim 6, wherein the interior of the unit is lined with a metallic film, the metallic film being constituted of a metallic material for frequency-selective magnetic shielding, and capable of magnetically shielding the interior of the unit vis-à-vis at least one predetermined radioelectric frequency.
